(19) United States
(12) Patent Application Publication
(10) Pub. No.: US 2025/0342180 A1
(43) Pub. Date: Nov. 6, 2025

(54) SYSTEM AND METHOD FOR SUGGESTING ANSWERS ON AGENT PERFORMANCE EVALUATION FORMS USING GENERATIVE ARTIFICIAL INTELLIGENCE

(71) Applicant: NICE LTD., Ra'anana (IL)

(72) Inventors: Nitin PABALE, Pune (IN); Mukul SAINI, Pune (IN); Harshit SHAH, Pune (IN)

(21) Appl. No.: 18/652,452

(22) Filed: May 1, 2024

(51) Int. Cl. G06F 16/332; G06F 16/335; G10L 15/26

(52) U.S. Cl. CPC G06F 16/3329; G06F 16/335; G10L 15/26

(57) ABSTRACT

A performance evaluation system and methods are provided that are configured to intelligently suggest answers to questions on performance evaluations using a generative artificial intelligence (AI) service. The system includes a processor and a computer readable medium operably coupled thereto, the computer readable medium comprising a plurality of instructions stored in association therewith that are accessible to, and executable by, the processor, to perform operations which include receiving a selection of an interaction between a user and an agent for a performance evaluation, fetching evaluation form data for the performance evaluation, determining a transcript of the interaction a request object for one or more suggested answers to the one or more questions, requesting the one or more suggested answers from the generative AI service, updating the performance evaluation to include the one or more suggested answer, and outputting the updated performance evaluation in an interface.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to artificial intelligence (AI) and machine learning (ML) systems and models, and more specifically to a system and method for automating generation of suggested answers to questions on evaluation forms using generative Als including large language models (LLMs).

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

In today's digital era, consumers typically engage with a company's customer service center through various digital platforms including voice calls, text/chat messages, or emails. Customers may seek solutions to their inquiries, complaints, or simply to get assistance from these service and other contact centers. To respond to their needs, customer service and contact centers may employ human agents to interact with customers and provide solutions. These agents may correspond to a workforce or employees of the company or third-party provider, such as a call center and/or set of employees of the company or a hired workforce that may be involved in sales, help, technical assistance, or the like. To provide better assistance, companies routinely monitor these calls and interactions. These recordings may be used to evaluate whether the agents are effectively resolving inquiries and providing adequate assistance to customers' inquiries.

As such, many companies add value to their business by operating call and contact centers, which allow their customers to receive support for products and services. With different customer relationship management (CRM) systems, agents may provide different assistance and communications with customers. Contact centers may use a variety of metrics to judge the performance of the center overall and the performance of their individual agents. For individual agents, companies may utilize quality management software (QMS) to assess the performance of their agents, which may also be used in overall center ranking. This software typically incorporates evaluation forms that include a variety of questions and answers covering a wide range of areas, such as agent behavior, issue resolution, etc. Users and/or evaluators may use these forms for evaluation and agent performance scoring. Scoring may be performed by providing answers to the questions in the evaluation form and/or by going through the recorded audio calls and interactions including examining text/chat/email-type communications.

These evaluations assist a company in determining whether agents are performing to their standards, or if one or more of the agents require improvement, thereby providing training opportunities and/or agent review. However, responses to scoring and/or answers to specific questions typically require evaluators to manually provide input, which is time consuming and requires significant recollection of and reflection on past calls and other engagements by agents with customers and other users. Often users or evaluators will forego this process or only provide responses when they have a particularly poor experience, thereby skewing results. Further, evaluators may default to short answers or foregoing further optional inputs, which may not provide real insights to agent performance. Thus, it is desirable to automate labor-intensive processes and improve evaluator efficiency when handling and responding to evaluation forms. Therefore, there is a need for an automated, intelligent, and efficient computing system and framework that can provide suggested answers for agent performance automatically on evaluation forms for evaluator approval or revision, which would improve efficiency and timeliness of evaluations.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified block diagram of a networked environment suitable for implementing the processes described herein according to an embodiment.

FIG. 2 is a simplified system architecture of a performance evaluation system that may interact with generative AI services for generating suggested answers to questions on forms for performance evaluations according to some embodiments.

FIGS. 3A and 3B are simplified diagrams for an autosuggest data processor that suggests answers to questions on forms by prompting a generative AI according to some embodiments.

FIGS. 4A and 4B are simplified diagrams for preparing data and prompts used to generate suggested answers for questions on forms by prompting a generative AI according to some embodiments.

FIG. 5 is a simplified diagram for prompting a generative AI using different prompting strategies to generate suggested answers for questions on forms according to some embodiments.

FIG. 6 is a simplified user interface where users may view suggested answers to questions on a performance evaluation form of an agent according to some embodiments.

FIG. 7 is a simplified diagram of an exemplary flowchart for suggesting answers on agent performance evaluation forms using generative AI according to some embodiments.

FIG. 8 is a simplified diagram of a computing device according to some embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Users, such as customers, managers, and other evaluators, may be provided with performance evaluations to evaluate agents or other employees of a CRM system and/or service, including call centers and other remote assistance service lines, centers, webchats and websites, and the like, through fillable forms. Such forms may require the evaluators to respond to answers to different questions, which may come in the form of multiple choice, text input, and the like. To aid users during the evaluation process, a feature may be offered in a QMS package and/or application, such as an “Auto Suggest” tool or option that allows users to designate different questions to have an intelligent system generate a suggested answer for selected questions. This feature may automatically suggest answers to questions on the evaluation form based on the data in a call or interaction. To initiate an evaluation, a user may select a call and/or interaction from the available list, such as by selecting an “Evaluate” option, button, or interface element. This may provide an option to choose an evaluation form or use a predefined or default evaluation form. The user may instead load a customized form that has been pre-supplied by a manager or other users. Once an evaluation form is selected, a user interface may subsequently load all the available questions in the selected evaluation form for a user to provide a response and/or answer as instructed.

In a regular scenario, to answer the questions on the evaluation form, a user is required to listen to or read the entire call and/or interaction. However, if the autosuggest feature of the present disclosure is enabled on the form and/or with certain questions, some of the questions may instead be prefilled with suggested answers. With this feature, the user still needs to answer the remaining questions on the form, but may have an initial suggestion that can serve as a basis for answering questions and providing input text. As such, the QMS application and service provider may integrate a new system, components, and processes into the evaluation process that employs generative AI models and systems, including those that utilize LLMs, to suggest answers on the chosen evaluation form, utilizing transcripts from calls and/or interactions. This adds an element of automation to the current process of answering questions on the evaluation form. Users can then simply verify the suggested answers and can publish the agent performance evaluation without requiring manual efforts and input to each evaluation question. As such, this may provide a significant reduction in the time required to complete evaluations, leading to improved assessment quality and increased user productivity.

Further, the service provider may create universal templates that can be utilized across sessions and media formats enabling the application of autosuggestions to all types of questions and forms. In this regard, queries during calls and other interactions may correspond to one or more words, phrases or other collections of words, sentences, and the like, typically used in a conversation between an agent and a customer or another user. Sessions may correspond to groupings of similar or distinct types of calls and/or interactions, which may have the queries applied on top of these sessions. As such, by using universal templates, the service provider may remove or lessen the reliance on sessions for query responses that are used with questions and answers on evaluation forms, as well as time-intensive configurations of evaluation forms. Additionally, users may be provided with the ability to review and modify these AI-generated responses for more accurate and precise responses.

To provide AI-based response suggestions, users may first mark specific questions for AI-based answer suggestions. Once a question is marked, users can then add a custom question prompt, or the system may create one dynamically. Additionally, further information at the evaluation form level may be provided including guidance, answer policies, or any relevant documents that aid in the evaluation process. Once a user selects the call and/or interaction for agent performance evaluation, a transcript may be retrieved and processed to determine the relevant data, such as the text, offset, speaker depending on the call type, etc. The generative AI may also process the transcript to extract relevant data, which may improve the transcript, make it more gender-neutral, and/or remove information that may cause AI bias. Whether to perform these steps may be based on an accuracy of suggestions versus a cost to process these steps and increase accuracy, and as such, may allow tenants, organizations, and/or clients of the CRM system to customize their options.

Thereafter, custom prompts for all the questions marked for generative AI suggestion in the evaluation form may be created and/or generated either manually by user or by the service provider's system using certain logic for prompting an LLM of a generative AI service. For subjective questions, the generative AI service may provide the answers in its own words based on training, selected data for answer generation, a knowledge basis, etc. Users may override this dynamic prompt creation by adding their own prompts for the questions as well. Using the transcript, additional data, and specific instructions, final transcript data is created. The final transcript data may be submitted and used to query a generative AI with the question prompts in groups of requests, queries, or messages. For example, the Azure OpenAI Service or similar generative AI and/or LLM service may be prompted using the aforementioned data. Prompting strategies may include a Retrieval-Augmented Generation (RAG) approach to prompting or direct application programming interface (API) calling with the prompt(s), however, other strategies and techniques may also be used. The prompting may be based on the users/organization configuration preferences so that responses are generated in the desired format that will appear on the evaluation form as the suggested answer.

As such, an intelligent system may be provided to solve the issues with manual inputs for answers and other responses to form-based questions, including those for performance evaluations of agents, using one or more AI models and systems that may utilize generative and/or conversational AI including LLMs for automated and intelligent context and memory capabilities by machines. This may include the use of GPT-4 or other generative pretrained transformers (GPTs), LLMs, or the like, to provide conversational and/or generative AI. For example, an LLM may provide natural language processing to analyze and understand large amounts of textual data related to transcripts, performance evaluations, additional data, instructions, and the like. By leveraging LLMs, generative AI services may provide natural language processing capabilities, allowing prompting for responses that analyze and interpret large amounts of data with accuracy and speed, thereby summarizing data and generating responsive and helpful answers for questions. LLMs and other generative AI may learn on past data available when evaluating questions on forms based on data provided for answer generation.

A computing service and framework may be coded, deployed, and made available to evaluators and other users that automatically generates suggested answers to form questions using generative AI models that may include and/or utilize LLMs, GPTs (e.g., GPT-4), or the like. The embodiments described herein provide methods, computer program products, and computer database systems for an ML system that programmatically processes, evaluates, and provides suggested answers to questions from forms for performance evaluations or other tasks. A CRM system, call center QMS application or suite, or other service provider system having one or more companies or businesses as customers or other tenants, may therefore include and/or utilize a suggested answer framework that may implement a performance evaluation system as described herein. The framework of intelligent automation for performance evaluation answers may provide evaluators with a powerful tool for effectively evaluating and responding to questions in a timely and efficient manner, minimizing needed user inputs. Models may be specifically trained and deployed for suggested answer generation through generative AI prompting, which allows for faster and more efficient responses and answers for form-based questions based on a knowledge basis or set of data for answering such questions. This provides an improved performance evaluation system while reducing manual efforts and wasted system resources.

According to some embodiments, in an ML system accessible by a plurality of separate and distinct organizations, ML algorithms, features, and models are provided of a performance evaluation system for providing suggested answers to questions intelligently and automatically, thereby providing faster, more efficient, and more precise automated answer suggestion.

### Example System and Computing Environment

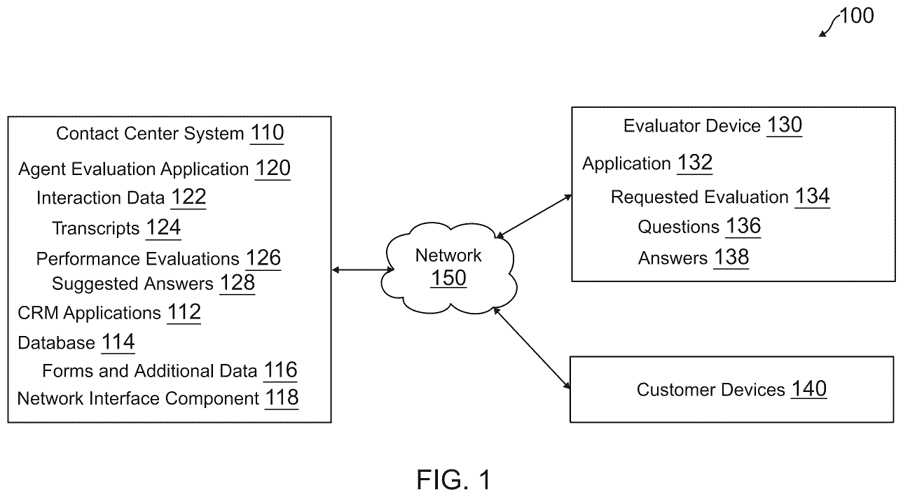

The system and methods of the present disclosure can include, incorporate, or operate in conjunction with, or in the environment of, an ML engine, model, and intelligent system, which may include an ML or other AI computing architecture that provides automated generation of suggested answers to questions on forms, such as agent performance evaluation forms of interactions between agents and customers or other users. Such answer suggestion may be generated using transcripts for interactions, form data for the form having the questions, additional relevant data for guidance, policies, or documents, and/or user defined prompt data for any specific question. FIG. 1 is a block diagram of a networked environment 100 suitable for implementing the processes described herein according to an embodiment. As shown, environment 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided, by such devices and/or servers may be combined or separated for a given embodiment and may be performed by a greater number or lesser number of devices and/or servers. For example, ML models, NNs, and other AI architectures have been developed to improve predictive analysis and classifications by systems in a manner similar to human decision-making, which increases efficiency and speed in performing predictive analysis on datasets requiring machine predictions, classifications, and/or analysis. One or more devices and/or servers may be operated and/or maintained by the same or different entities.

FIG. 1 illustrates a block diagram of an example environment 100 according to some embodiments. Environment 100 may include a contact center system 110, an evaluator device 130, and customer devices 140 that interact over a network 150 to provide intelligent answer suggestion for questions using generative AI including LLMs, as discussed herein. In other embodiments, environment 100 may not have all of the components listed and/or may have other elements instead of, or in addition to, those listed above. In some embodiments, environment 100 is an environment in which an agent evaluation application 120 may prompt and/or execute ML and NN models, such as LLMs and other generative Als, to orchestrate the processes for automated answer suggestion to different questions. As illustrated in FIG. 1, contact center system 110 might interact via a network 150 with evaluator device 130 to generate, provide, and output answer suggestions to questions on forms via an application 132 on evaluator device 130.

For example, in contact center system 110, CRM applications 112 may provide CRM services to users, agents, companies, and the like, which may be configured to interact with customer devices 140 and/or agents and agent devices including call centers and call center systems and devices. Contact center system 110 may provide a user interface (e.g., through CRM applications 112 of contact center system 110) for users to communicate, via customer devices 140, with an agent, which may result in corresponding interaction data 122 for a voice call or the like (e.g., chat logs, videos, etc.). For example, CRM applications 112 may be used to perform, record, and/or process calls with customer device 140 by agents, which may generate interaction data 122 that is processed, transformed, and/or transcribed into transcripts 124 used for LLM or other generative AI prompting (e.g., to GPT-4 or other GPT). As such, agent evaluation application 120 may correspond to QMS that includes operations and APIs to access and retrieve interaction data 122 and transcripts 124 from CRM applications 112 when an interaction of interest for a performance evaluation is to be processed and handled for that performance evaluation. Transcripts 124 may correspond to a text data log or file of the corresponding communications between the customer(s) and agent(s).

As such, contact center system 110 may be utilized to provide CRM operations to tenants, customers, and other users or entities via CRM applications 112, as well as answer suggestion operations using LLMs, generative Als, NNs, and/or other ML models using agent evaluation application 120. To provide answer suggestion, agent evaluation application 120 may be invoked and utilized to intelligently generate answers based on a request from evaluator device 130 or another device, system, or component, for a requested evaluation 134 being reviewed and responded to in application 132, as discussed herein. This may include processing questions 136 on a corresponding form for requested evaluation 134 to determine if any of answers 138 may be suggested on request to questions 136. To do so, agent evaluation application 120 may prompt an LLM of a generative AI system, component, internal or external platform, or the like using information associated with requested evaluation 134. Prompting may utilize an interaction transcript, question and/or answer data from a corresponding form, additional data associated with the performance evaluation, agent, and/or company, and/or user defined prompt data for the questions and/or answers.

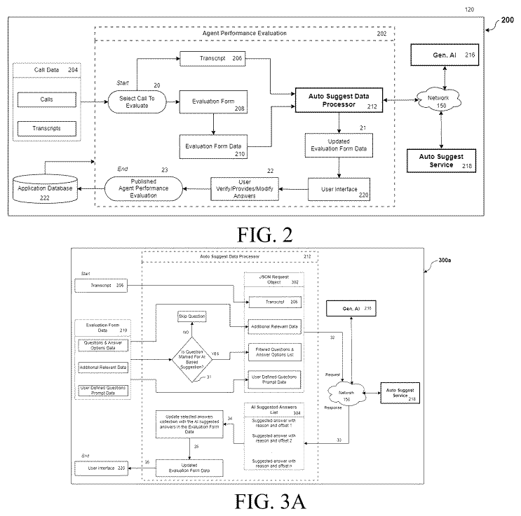

For example, agent evaluation application 120 may access and process performance evaluations 126 to determine suggested answers 128 by prompting an LLM of a generative AI and receiving suggested answers based on intelligent processing of the prompt data. Intelligent processing may be performed based on a training and/or knowledge base for the LLM (e.g., training data used to train the ML model, NN, or the like of the LLM). Performance evaluations may include form data that may be associated with the questions being provided to evaluators (e.g., “How well did the agent perform their duties?) and any answer information to those questions, such as an answer query (e.g., “Please list examples of the agent's performance” or “Score from 1-10”). A transcript of the interaction of interest to the evaluation may be used for the LLM to generate suggested answers, although other sources of data may also be used including chat logs, emails, and other communications, or for different forms, different documents, corpora of documents, and/or informational base for form answering. Further, additional data relevant to the form, agent, or company may be used including guidelines, policies, and the like, as well as user defined prompt data that may limit answers to specific user defined prompts and their parameters or guidelines. Thereafter, agent evaluation application 120 may generate prompts and prompt the LLM, which may return suggested answers 128. These may then be output to evaluator device 130 for answers 138, which may be reviewed, approved, and/or changed by the evaluator or other user. The operations to generate suggested answers by prompting an LLM are discussed in more detail with regard to FIGS. 2-7 below.

As such, agent evaluation application 120 may leverage generative Als, LLMs, GPTs including GPT-4, and the like to integrate such models for generative AI services for performance evaluations and other suggested answer generation. Agent evaluation application 120 may not rigidly specify a specific generative AI model and generative AI models, LLMs, GPTs, and the like may be modularly added or removed based on changes and advancements. Further, agent evaluation application 120 may not be restricted to calling generative AI services and LLMs once or a limited number of times, and suggested answers 128 may be generated piece-by-piece or by providing examples, although single calls may be preferred in certain embodiments. For LLMs and other ML models (e.g., decision trees and corresponding branches, NNs, clustering operations, etc.) including those used by agent evaluation application 120, the models may be trained using training data, which may correspond to stored, preprocessed, and/or feature transformed data associated with performance evaluation forms, transcripts, and the like, as well as other conversational skills. With continuous and/or reinforcement training, live streaming data from one or more production, live, and/or real-time computing environments and/or feedback from different entities may be used. Model training and configuring may include performing feature engineering and/or selection of features or variables used by ML models. Features or variables may correspond to discreet, measurable, and/or identifiable properties or characteristics.

LLMs, ML modes, and NNs used by contact center system 110 may be trained using one or more ML algorithms, operations, or the like for modeling (e.g., including configuring decision trees or neural networks, weights, activation functions, input/hidden/output layers, and the like). Thus, one or more ML models, NNs, or other AI-based models and/or engines may be trained for suggested answer generation for performance evaluation forms and questions, or another ML task. The training data may be labeled or unlabeled for different supervised or unsupervised ML and NN training algorithms, techniques, and/or systems. Contact center system 110 may further use features from such data for training, where the system may perform feature engineering and/or selection of features used for training and decision-making by one or more ML, NN, or other AI algorithms, operations, or the like (e.g., including configuring decision trees, weights, activation functions, input/hidden/output layers, and the like). A model may then be trained using a function and/or algorithm for the model trainer. The training may include adjustment of weights, activation functions, node values, and the like. After initial training of models, models may be evaluated and/or released in a production computing environment. For example, LLMs may be used to provide conversational AI skills and performance, which may utilize training and a knowledge base to respond to queries and other prompts from users.

One or more client devices and/or servers (e.g., evaluator device 130 using application 132) may execute a web-based client that accesses a web-based application for contact center system 110, or may utilize a rich client, such as a dedicated resident application, to access contact center system 110, which may be provided by CRM applications 112 to such client devices and/or servers. Evaluator device 130 and/or other devices or servers may utilize one or more application programming interfaces (APIs) to access and interface with CRM applications 112 and/or agent evaluation application 120 of contact center system 110 in order to access, review, and evaluate suggested answers provided for performance evaluation forms and questions, as discussed herein. Interfacing with contact center system 110 may be provided through CRM applications 112 and/or agent evaluation application 120, which may be based on data stored by database 114 of contact center system 110 and/or a database of evaluator device 130. In this regard, forms and additional data 116 may be used to provide requested evaluation 134 to evaluator device 130 and may further be processed when generating suggested answers 128.

Contact center system 110, evaluator device 130, customer devices 140, and/or other devices and servers on network 150 might communicate with contact center system 110 using TCP/IP and, at a higher network level, use other common Internet protocols to communicate, such as hypertext transfer protocol (HTTP or HTTPS for secure versions of HTTP), file transfer protocol (FTP), wireless application protocol (WAP), etc. Communication between evaluator device 130 and contact center system 110 may occur over network 150 using a network interface component 118 of contact center system 110 and corresponding interfaces, connections, and the like of evaluator device 130. In an example where HTTP/HTTPS is used, evaluator device 130 might include an HTTP/HTTPS client for application 112, commonly referred to as a “browser,” for sending and receiving HTTP//HTTPS messages to and from an HTTP//HTTPS server, such as contact center system 110 via the network interface component.

Similarly, contact center system 110 may host an online platform accessible over network 150 that communicates information to and receives information from evaluator device 130. Such an HTTP/HTTPS server might be implemented as the sole network interface between evaluator device 130 and contact center system 110, but other techniques might be used as well or instead. In some implementations, the interface between evaluator device 130 and contact center system 110 includes load sharing functionality. As discussed above, embodiments are suitable for use with the Internet, which refers to a specific global internet of networks. However, it should be understood that other networks can be used instead of or in addition to the Internet, such as an intranet, an extranet, a virtual private network (VPN), a non-TCP/IP based network, any LAN or WAN, or the like.

Evaluator device 130 and other components in environment 100 may utilize network 150 to communicate with contact center system 110 and/or other devices and servers, and vice versa, which is any network or combination of networks of devices that communicate with one another. For example, network 150 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global inter network of networks often referred to as the Internet, network 150 may correspond to such a network using the TCP/IP protocol for data transfer. However, it should be understood that the networks that the present embodiments might use are not so limited, although TCP/IP is a frequently implemented protocol. Further, one or more of evaluator device 130 and/or contact center system 110 may be included as part of the same system, server, and/or device and therefore communicate directly or over an internal network.

According to one embodiment, contact center system 110 is configured to provide webpages, forms, applications, data, and media content to one or more client devices and/or to receive data from evaluator device 130 and/or other devices, servers, and online resources. In some embodiments, contact center system 110 may be provided or implemented in a cloud environment, which may be accessible through one or more APIs with or without a corresponding graphical user interface (GUI) output. Contact center system 110 further provides security mechanisms to keep data secure. Additionally, the term “server” is meant to include a computer system, including processing hardware and process space(s), and an associated storage system and database application (e.g., object-oriented data base management system (OODBMS) or relational database management system (RDBMS)). It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

In some embodiments, evaluator device 130, shown in FIG. 1, executes processing logic with processing components to provide data used for CRM applications 112 and/or agent evaluation application 120 of contact center system 110, such as during performance evaluations of agents and generation of suggested answers. In one embodiment, evaluator device 130 includes application servers configured to implement and execute software applications as well as provide related data, code, forms, webpages, platform components or restrictions, and other information, and to store to, and retrieve from, a database system related data, objects, and web page content. For example, contact center system 110 may implement various functions of processing logic and processing components, and the processing space for executing system processes, such as running applications. Evaluator device 130 and contact center system 110 may be accessible over network 150. Thus, contact center system 110 may send and receive data to evaluator device 130 via network interface component 118. Evaluator device 130 may be provided by or through one or more cloud processing platforms, such as Amazon Web Services® (AWS) Cloud Computing Services, Google Cloud Platform®, Microsoft Azure® Cloud Platform, and the like, or may correspond to computing infrastructure of an entity, such as a financial institution.

Several elements in the system shown and described in FIG. 1 include elements that are explained briefly here. For example, evaluator device 130 could include a desktop personal computer, workstation, laptop, notepad computer, PDA, cell phone, or any wireless access protocol (WAP) enabled device or any other computing device capable of interfacing directly or indirectly to the Internet or other network connection. Evaluator device 130 may also be a server or other online processing entity that provides functionalities and processing to other client devices or programs, such as online processing entities that provide services to a plurality of disparate clients. Evaluator device 130 may run an HTTP/HTTPS client, e.g., a browsing program, such as Microsoft's Internet Explorer or Edge browser, Mozilla's Firefox browser, Opera's browser, or a WAP-enabled browser in the case of a cell phone, tablet, notepad computer, PDA or other wireless device, or the like. According to one embodiment, evaluator device 130 and all of its components are configurable using applications, such as a browser, including computer code run using a central processing unit such as an Intel Pentium® processor or the like. However, evaluator device 130 may instead correspond to a server configured to communicate with one or more client programs or devices, similar to a server corresponding to contact center system 110 that provides one or more APIs for interaction with evaluator device 130.

Thus, evaluator device 130 and/or contact center system 110 and all of their components might be operator configurable using application(s) including computer code to run using a central processing unit, which may include an Intel Pentium® processor or the like, and/or multiple processor units. A server for evaluator device 130 and/or contact center system 110 may correspond to Window®, Linux®, and the like operating system server that provides resources accessible from the server and may communicate with one or more separate user or client devices over a network. Exemplary types of servers may provide resources and handling for business applications and the like. In some embodiments, the server may also correspond to a cloud computing architecture where resources are spread over a large group of real and/or virtual systems. A computer program product embodiment includes a machine-readable storage medium (media) having instructions stored thereon/in which can be used to program a computer to perform any of the processes of the embodiments described herein utilizing one or more computing devices or servers.

Computer code for operating and configuring evaluator device 130 and contact center system 110 to intercommunicate and to process webpages, applications and other data and media content as described herein are preferably downloaded and stored on a hard disk, but the entire program code, or portions thereof, may also be stored in any other volatile or non-volatile memory medium or device, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

### Performance Evaluation System

FIG. 2 is a simplified system architecture 200 of a performance evaluation system that may interact with generative AI services for generating suggested answers to questions on forms for performance evaluations according to some embodiments. System architecture 200 of FIG. 2 includes a representation of the components and processes for an agent performance evaluation 202 that may be performed by contact center system 110 using agent evaluation application 120 discussed in reference to environment 100 of FIG. 1. In this regard, system architecture 200 displays the interactions to provide agent performance evaluation 202 that may include automatic generation of suggested answers for questions on one or more forms.

For example, customer devices, such as phones, computers, etc., may be used to interact with an agent device or vice versa via a network to avail a customer or other user of the CRM services, assistance, and the like for contact center system 110. These interactions may occur differently via a communication application of the agent's device and/or provided by CRM applications 112 of contact center system 110, which may correspond to a software application, API, or any user interface capable of making or receiving audio calls, online chat, emails, text messages, etc. As such, the communication application may facilitate recording the communication between the customer and agent for storage in an available, shared, or propriety format for data security. These recorded interactions may include calls, as well as other communications, which may be ingested and/or imported from the communication application and/or by CRM applications 112 to create call data 204 corresponding to the calls and/or transcripts for the different interactions by agents with users. For example, for the call between the agent and customer, a transcript 206 may be included with call data 204 and processed for answer suggestion.

As such, call data 204 may include transcripts having text data logs and the like of corresponding communications between customers and agents. CRM applications 112 may have multiple application databases used to store several types of data as needed for different answer suggestion scenarios. For example, an SQL server may be hosted on a different server/machine connected to CRM applications 112 via an internal network, and the like, which may be used for storage of call data 204 including transcript 206 that may be queried for and retrieved. To monitor agent performance, CRM applications 112 in contact center system 110 may include a quality management process, operation, or application, such as agent evaluation application 120, which may perform agent performance evaluation 202 in system architecture 200. This may be done based on an evaluation form 208 that contains questions and their answer options to determine/evaluate the agent's performance during the call or other interaction(s). Evaluation form 208 may also be associated with and/or include an option to add additional relevant data, which may correspond to policies, answer parameters or restrictions, domains or bases for knowledge, laws or regulations, and the like. Evaluation form data 210 may therefore be stored for evaluation form 208 having the associated relevant data and the like (e.g., question-and-answer forms including answer options).

To provide autosuggestion of answers, an autosuggest data processor 212 may be in communication over network 150 with a generative AI service instance 216 and an autosuggest service 218. Generative AI service instance 216 may be integrated with autosuggest data processor 212 to provide generative AI components including one or more LLMs that may provide intelligent generation of suggested answers. LLMs for generative AI service instance 216 may include Azure OpenAI, Google Bard, etc., although other and/or proprietary LLMs may be used. To send a request to these LLM services from any application, a public or private instance of the service may be procured and/or instantiated. For example, a private instance of Azure OpenAI may correspond to generative AI service instance 216 that is consumed via the third-party Python libraries such as OpenAI and LangChain. This enables use of an LLM, such as GPT4 (32K), GPT-35-Turbo, Text-Davinci-003, embeddings model text-embedding-ada-002, or the like. Databases for data storage and retrieval may correspond to vector database for AI-related data including embeddings and/or relational databases such as Microsoft SQL Server for CRM application data, however, other alternatives, such as Oracle, MySQL, and No SQL databases, may also be used. Autosuggest data processor 212 may further be in communication with autosuggest service 218, which may correspond to a representational state transfer (REST) API service that can be deployed along with the other ones of CRM applications 112, inside the QMS application or service (e.g., agent evaluation application 120), or on a separate server/machine. The REST API endpoints available in this service may be called via network 150 by an autosuggest data processor 212 during answer suggestion.

In this regard, system architecture 200 may represent a high-level flow for autosuggest service 218 integrated with an evaluation process of quality management application 120. At step 20, agent performance evaluation 202 may begin by accessing, fetching, and/or retrieving call data 204 including a transcript 206. At step 20, an evaluator or another user selects one of the interactions from call data 204, such as by clicking on an evaluate button. A user interface may open where the user may select or use a predefined evaluation form or otherwise provide information for evaluation form 208. After evaluation form 208 is selected, evaluation form data 210 may be fetched, which contains a question-and-answer collection with additional relevant data and any user-defined prompt data that may be provided with selection of evaluation form 208 and/or request for answer suggestion. In parallel at step 20, transcript 206 of the selected call may also be fetched.

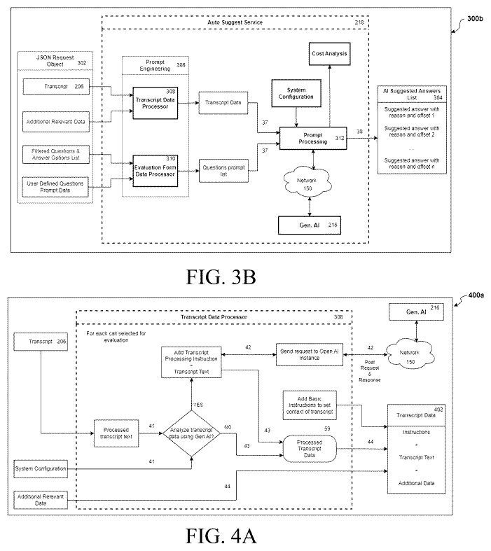

This data for transcript 206 and evaluation form data 210 may then be sent to autosuggest data processor 212, which may invoke autosuggest service 218 and generative AI service instance 216 over network 150 to provide the suggested answers. The output of autosuggest data processor 212 at step 21 may correspond to an updated evaluation form data that contains the suggested answers, which, at step 21, may be rendered on user interface 220. The user interface may include one or more visualizations, menus, data, and the like where the user may be provided an option to verify or modify the AI suggested answers. Thus, at step 22, the user may verify and/or approve the suggested answers or may be provided an option to revise and/or provide answers to those questions that did not have acceptable suggested answers and/or were not marked for AI-based suggestion. After completing step 22, the user may publish the agent performance evaluation, at step 23, which may be saved to an application database 222 as published evaluation data for agent evaluation application 120 or other QMS application. These components and steps of system architecture 200 in FIG. 2 is further described below with regard to FIGS. 3A-7.

FIGS. 3A and 3B are simplified diagrams 300a and 300b for an autosuggest data processor that suggests answers to questions on forms by prompting a generative AI according to some embodiments. For example, diagram 300a of FIG. 3A shows autosuggest data processor 212 in further detail, while diagram 300b of FIG. 3B shows autosuggest service 218 in further detail. In this regard, FIG. 3A shows the flow of diagram 300a of autosuggest data processor 212, which may include processing a JavaScript Object Notation (JSON) request object 302 to provide an AI suggested answer list 304 that may be output for answer suggestions in user interface 220. In this regard, autosuggest data processor 212 may be used to create JSON request object 302 that will be sent as a post request to an endpoint corresponding to autosuggest service 218 over network 150. Autosuggest data processor 212 may then process the response coming from autosuggest service 218 to create a further JSON object or other data container for AI suggested answer list 304 to be rendered on user interface 220.

JSON request object 302 may be created by first filtering out the questions from the question-and-answer options data of evaluation form data 210, including removing those questions that are not marked for AI based suggestions, at step 31. JSON request object 302 is then generated using and/or updated to include a filtered question-and-answer options list. JSON request object 302 may further include transcript 206, additional relevant data, and/or user defined questions prompt data, which may be used for suggested answer determination. Additional relevant data may be useful when companies want to provide guidance, answer policies, or any relevant documents that aid in the evaluation process for suggested answers, while user defined questions prompt data may allow for users to specify specific prompts for questions that are to be used when generating answer suggestion to questions, such as instructions, a domain, field, or set of data for intelligent answer generation by an LLM or the like. As such, the filtered question-and-answer options list and transcript 206, as well as additional relevant data and user defined questions prompt data taken from the evaluation form data 210 may be used to create JSON request object 302 for processing, at step 31.

At step 32, a request is sent to autosuggest service 218 via network 150 as a post API request. This request may include JSON request object 302 for prompt engineering and generation, as shown in further detail with regard to diagram 300b. Thus, after generation, the prompts may be sent to generative AI service instance 216 for answer suggestion. Autosuggest data processor 212 may receive a JSON object or other data container, message, structure, or the like for AI suggested answer list 304, at step 33, from autosuggest service 218. AI suggested answers list 304 therefore contains the collection of suggested answers along with their reasoning and speaker offset for identifying an exact time in the call/recording to justify the suggested answer and/or reasoning. This request may be parsed to create a specific data structure, which may be used to update the selected answers in evaluation form, at step 35. Further at step 35, the updated evaluation form data is then generated, which may be transmitted between systems and components. This data is then rendered on user interface 220, at step 36.

In diagram 300b of FIG. 3B, autosuggest service 218 may accept the post request containing JSON request object 302 from step 32 of diagram 300a, which may include transcript 206, additional relevant data, the filtered question-and-answer options list, and user defined questions prompt data. Autosuggest service 218 may then initiate prompt engineering 306, which may include two main processors, a transcript data processor 308 and an evaluation form data processor 310, which may generate and provide transcript data and questions prompt list, respectively, to a prompt processing 312, at step 37.

Transcript data processor 308 may use transcript 206 (as well as any additional relevant data) to generate processed transcript data along with some instructions to set a context of the transcript. This data may correspond to the source data on which the LLM is to utilize to process the question prompts and provide suggested answers. Evaluation form data processor 310 may use the filtered question-and-answer options list (as well as any user defined questions prompt data) to create a questions prompt list. Prompts may therefore include a set of instructions that the LLM is to answer using the source data. As such, the processed transcript data and the questions prompt list may then be sent to the prompt processing 312 at step 37. In some embodiments, prompt processing 312 may use system configuration data and parameters (e.g., those system configurations that may be defined by a system administrator) to determine how to send the request to generative AI service instance 216 to obtain suggested answers from LLM prompting. Once returned, these generative AI suggested answers to selected questions may then be formatted and returned as a JSON response object or the like having AI suggested answers list 304, at step 38.

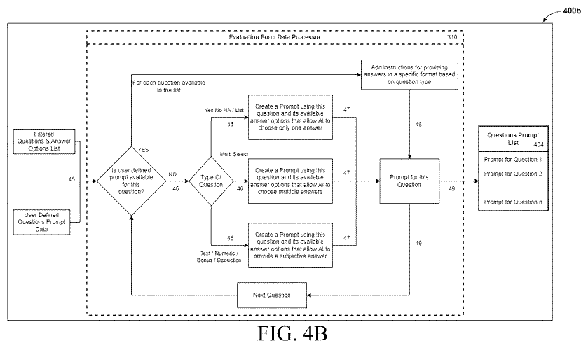

FIGS. 4A and 4B are simplified diagrams 400a and 400b for preparing data and prompts used to generate suggested answers for questions on forms by prompting a generative AI according to some embodiments. Diagrams 400a and 400b of FIGS. 4A and 4B include tasks, operations, and corresponding steps that may be executed by transcript data processor 308 and evaluation form data processor 310 to provide data used to generate prompts. Such prompts may be used to prompt an LLM and generate answer suggestions that may be output to evaluators by contact center system 110 discussed in reference to environment 100 of FIG. 1 AIs.

Diagram 400a of FIG. 4A shows operations performed by transcript data processor 308 to generate transcript data 402 used during prompt generation and/or engineering. In this regard, at step 41, the flow of transcript data processor 308 may be used to process transcript 206 selected based on a call or interaction type associated with transcript 206. For example, if the type is audio, information including one or more of speaker type, offset, and text information may be extracted from transcript 206, and the corresponding processed transcript text may be used for processing the transcript data using a generative AI, at step 42. Further at step 41, system configurations may be used to determine whether to analyze such processed transcript data using generative AI.

In some embodiments, generative AI may be used to process transcripts to create a more gender-neutral transcript data and/or remove critical information that could cause AI bias. This extra processing may increase the accuracy of answer generation but also have a corresponding cost, which may be weighed against the benefits for system implementation. As such, at step 42, the alternate approach of processing the transcript using generative AI is shown. At step 42, transcript data processor 308 may add AI processing instruction to change the transcript to be gender-neutral and remove transcript errors, such as wrongly split or fragmented sentences. Along with this instruction and transcript data, a prompt may be created and sent to generative AI service instance 216 via network 150, such as using the OpenAI Python library. At step 43, the response from generative AI service instance 216 may then be used to generate transcript data 402 at a following step 44.

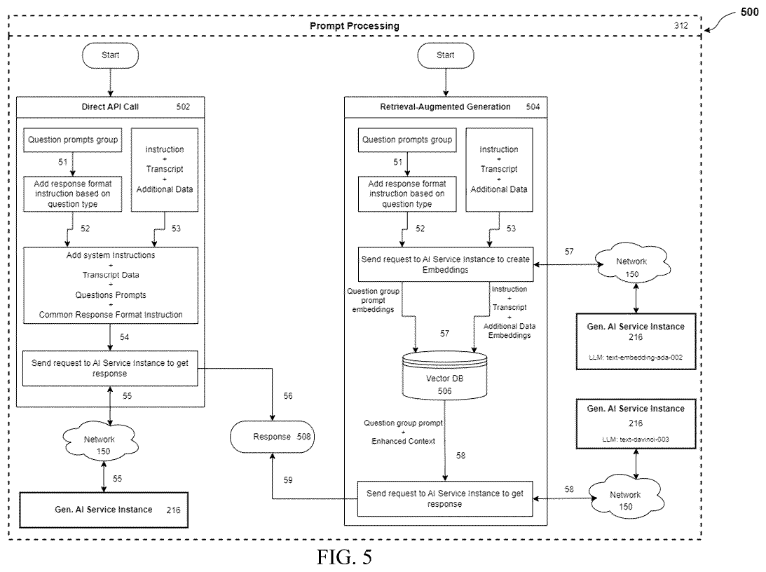

In alternative embodiments, generative AI service instance 216 may not be used and/or required for analyzing the processed transcript data from step 41. Instead, at an alternative route for step 43, the processed transcript data is sent directly to step 44 for additional processing to generate transcript data 402. At step 44, after processing the transcript data, an instruction is prefixed to the data that sets a context of the transcript for generative AI service instance 216. Further, additional data may be added as a suffix to the processed transcript data, which may be used with the instructions and transcript data to generate transcript data 402. Transcript data 402 may then be used for subsequent prompt generation, shown in FIG. 5 below.

Referring now to FIG. 4B, diagram 400b of FIG. 4B shows operations performed by evaluation form data processor 310 to generate questions prompt list 404 used during prompt generation and/or engineering. Diagram 400b shows a flow of operations executed by evaluation form data processor 310, which may process a filtered question-and-answer options list with user defined questions prompt data to create a questions prompt list 404. As such, diagram 400b shows logic that may be designed and/or utilized for prompting an LLM of a generative AI service for answer suggestion to evaluation form questions. At step 45, evaluation form data processor 310 may iterate processing over the filtered question-and-answer options list, and, for each question in the list, check if there is user defined questions prompt data for a user defined prompt that may be used in place of procedurally generating a prompt. As such, a user may define the prompt and/or parameters or information for the prompt, or, in the absence of a user definition, the prompt may be procedurally generated.

If a user defined prompt is not available for the question, then based on the type of the question, evaluation form data processor 310 may create a dynamic prompt by using question text, formatted answer options, and special instructions to restrict AI answers based on the type of question, at step 46. A resulting prompt for the question is then generated at step 47. However, if user defined questions prompt data is available, this data may be considered as the final prompt for the question. As such, instructions may be added to the user defined prompt for the generative AI to provide an answer in a specific format based on the question type, at step 48. Once the prompt is generated from step 47 or 48, the dynamic prompt or the user defined question prompt, for step 47 or 48 respectively, may then be pushed into a data set or prompt collection, at step 49, thereby creating questions prompt list 404. Questions prompt list 404 may then be processed with transcript data 402 by an LLM of a generative AI service, as shown in the following FIG. 5.

FIG. 5 is a simplified diagram 500 for prompting a generative AI using different prompting strategies to generate suggested answers for questions on forms according to some embodiments. Diagram 500 shows two different prompting strategies that may be utilized to elicit responses from an LLM, such as generative AI service instance 216, based on prompts having instructions and corresponding prompt data (e.g., data associated with a field, domain, set of information, documents or corpora of documents, etc., that may be used to respond to an instruction). As such, diagram 500 may correspond to two alternative prompting strategies for generating answer suggestions may be used by agent evaluation application 120 of call center system 110 in environment 100 of FIG. 1, although other prompting strategies may also be utilized.

In this regard, prompts may correspond to text or other input that contains information and instructions to a generative AI model or LLM. The prompts may be configured to obtain a desired output in the form of a response (e.g., text or other output data) to the information and instructions. These may be conversational responses or other AI responses that may be used for automated answer suggestions to questions on forms. The prompts may be created based on guidelines set by the company and/or other entity providing the form, type of form used, structure of the input data, and the prompting strategies that may be identified as most effective. As such, prompts may be developed for past high-quality responses by LLMs for answer suggestions. Prompting may therefore correspond to a technique of providing instructions as part of the input to the model on how the model should generate a corresponding output. As such, the prompts may instruct the model of the LLM how to generate an answer for a question using data passed with the prompts. Since not all prompts may create the same type and/or quality of output, specific prompting strategies that receive good quality answers for questions from generative Als and/or LLMs may be identified and used.

Prompts may be created that are to be passed to the generative AI service (e.g., an LLM or the like) by embedding the examples, instructions, and the like with the input JSON components or request objects. This may be done as an operation (e.g., string concatenation) in Python or the like (e.g., used for the corresponding library), which may create prompts having the extracted and/or formatted data in input JSON form. In this regard, prompting may correspond to a technique of providing instructions as part of the input to the generative AI model on how the model should generate its output. In the left side approach to LLM prompting in diagram 500, a flow for a direct API calling 502 is shown for the prompting strategy. Direct API calling involves sending a set of API calls directly to the LLM with instructions and the corresponding data from which the LLM is to utilize to respond to the instructions. The API calls may be sent to an API of the LLM and/or generative AI service instance 216, which may then process and respond to such calls. Initially, prompt processing 312 may result in question prompts groups where a number of questions are collected into one or more groups based on system configuration and/or prompting strategy. This may be based on questions prompt list 404, which may result in how many questions may be processed in each request to the LLM.

In the approach of direct API calling 502, at step 51, the question prompts available in the question prompts group may be read, obtained, and/or processed. A response format instruction may be added, at step 52, based on the question type, which may create concatenated questions prompt data. At step 53, transcript data may be combined with any additional data and a system level instruction. For example, a prompt may include the following instructions with added format instructions and/or other additional data: “You are a Medical Claims Company, customer service representative (CSR) performance evaluator. You will be provided with the call transcript data, in this transcript any personal information like names, dates, and numbers have been altered or removed for privacy, so consider them correct or ignore them. The transcript contains a conversation between the Agent and the Customer. Your role involves analyzing these transcript conversations and providing the answers to the questions asked by the user. The answer should be driven by the Question and Intent of the question provided by the user along with the transcript.”

At step 54, the aforementioned data is concatenated together along with common answer formatting instructions to create a final request prompt, which may be used for direct API calling 502 to the API of generative AI service instance 216. In this regard, at step 55, the concatenated data in the form of a JSON request object or the like may be sent through an API call to a chat completion API endpoint of generative AI service instance 216 via network 150. This calling may be done using a Python library, such as an OpenAI Python library for Azure OpenAI services. As such, the system performing direct API calling 502 may provide an option to process the request/prompt with one of the chat deployment models available in the system configuration for the LLM that is being called for prompt response. These models may include GPT-3.5-Turbo, GPT-4, GPT-4-32k, and the like, however, other automated chat models may also be used for LLM conversing and messaging. Where Azure OpenAI services may be used, Azure OpenAI may provide REST API access to OpenAI's LLMs including GPT-4, GPT-3.5-Turbo, and Embeddings model series. Generative AI service instance 216 may accept the combined transcript and question prompts or embeddings as the request via the software library for the API and return the plain text for a response 508 over the network 150. At step 56, response 508 may then be output for answer suggestion in one or more user interfaces and/or forms for performance evaluation or other question-and-answer type forms, reviews, tests, and the like.

Alternatively, or in addition (e.g., where multiple prompts and prompting strategies may be required), Retrieval-Augmented Generation (RAG) 504 may also be utilized as an approach to LLM prompting. In the RAG approach, the capabilities of the software and applications of generative AI service instance 216 may be used with a RAG algorithm. RAG begins with steps 51-53 in the same manner as direct API calling 502. Using the concatenated questions prompt data, transcript data, additional data, system level instruction, and the like from steps 52 and 53, at step 57, embeddings may be created using an embeddings LLM of generative AI service instance 216. This LLM may correspond to LLM Text-Embedding-Ada-002 or other text embeddings model, which may be called over network 150. The resulting embeddings may be stored to a vector database 506 or an alternative application database that supports vectors. This may be implemented using the python library LangChain. After creating the embeddings, at step 58, the embeddings of the questions prompt group are combined with instructions to answer each question and a common answer formatting, at step 58, and sent as a request to generative AI service instance 216. At step 59, generative AI service instance 216 may compare the embeddings of the questions with the transcript data embeddings using cosine similarity or the like, which then allows for similarities to be passed down to another LLM that converts the comparisons to a human-readable text in specific format for response 508. Thus, step 59 results in response 508 being output for the answer suggestions.

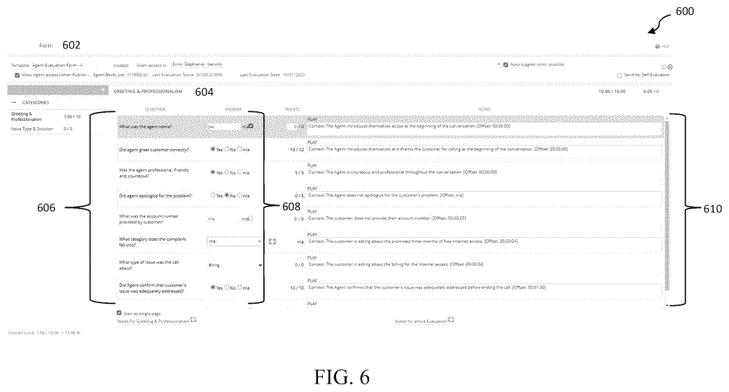

FIG. 6 is a simplified user interface where users may view suggested answers to questions on a performance evaluation form of an agent according to some embodiments. User interface 600 displays an exemplary form 602 for a performance evaluation 604 of a user, such as an agent, of a company, call center, or another employer. In this regard, user interface 600 may be displayed in response to automated answer generation and suggestion by a generative AI service including LLMs and the like. As such, user interface 600 may be displayed on evaluator device 130 during completion of performance evaluation 604 so that data may be entered in form 602 include suggestions of answers by agent evaluation application 120 of contact center system 110 when utilizing LLMs for question prompting and answer suggestion.

For example, form 602 may include questions 606 that may be responded to by the evaluator when completing performance evaluation 604. Certain ones of questions 606 may be marked of autosuggestion by an LLM (or all may be selected or defaulted for selection), and as such, may be processed, as discussed herein. Questions 606 may be associated with answer options 608, which may provide further context and information as to how each of questions 606 may be answered. As such, based on questions 606 and answer options 608, suggested answers 610 may be automatically generated by an LLM or other generative AI. The text for suggested answers 610 may be provided in text fields of form 602 for performance evaluations 604. Thereafter, the evaluator may review user interface 600 in order to accept, change, or otherwise utilize suggested answers 610 when completing performance evaluation 604.

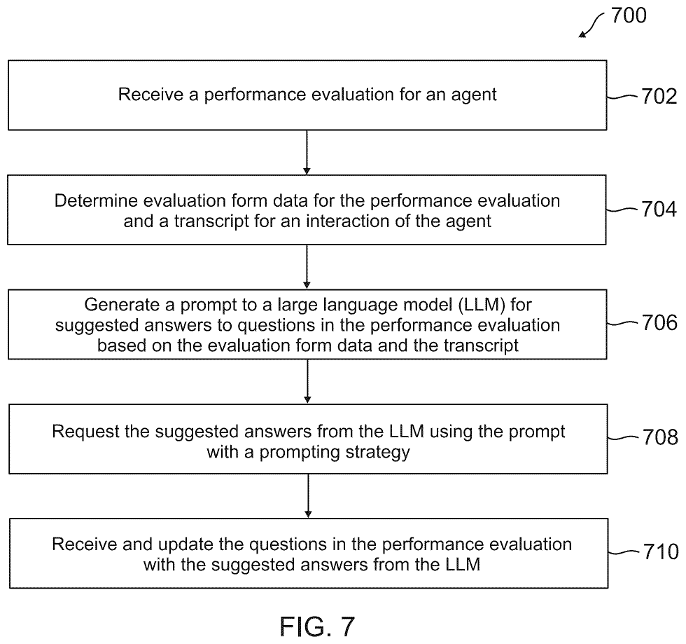

FIG. 7 is a simplified diagram of an exemplary flowchart 700 for suggesting answers on agent performance evaluation forms using generative AI according to some embodiments. Note that one or more steps, processes, and methods described herein of flowchart 700 may be omitted, performed in a different sequence, or combined as desired or appropriate based on the guidance provided herein. Flowchart 700 of FIG. 7 includes operations executable by a performance evaluation system that generates suggested answers automatically for questions on forms, as discussed in reference to FIG. 1-6. One or more of steps 702-710 of flowchart 700 may be implemented, at least in part, in the form of executable code stored on non-transitory, tangible, machine-readable media that when run by one or more processors may cause the one or more processors to perform one or more of steps 702-710. In some embodiments, flowchart 700 can be performed by one or more computing devices discussed in environment 100 of FIG. 1.

At step 702 of flowchart 700, a performance evaluation for an agent is received. The performance evaluation may be received in response to the agent, a customer, or another evaluator selecting an interaction of the agent to review and provide feedback via a performance evaluation, which may include automatic evaluations by a system for random, periodic, or scheduled reviews. As such, the interaction(s) for review and evaluation may be associated with one or more calls or other communication sessions between the agent and one or more users, for example, when a user may call into a call center and request assistance from the agent. Thus, the performance evaluation may assess the performance of the agent in handling the interaction and providing proper assistance, support, information, or the like.

At step 704, evaluation form data for the performance evaluation and a transcript for an interaction of the agent are determined. The evaluation form data may correspond to question-and-answer fields, queries, requests, or the like on a form for the performance evaluation. As such, the evaluation form data may be used to identify the questions that require answers to be automatically generated and suggested to the evaluator. The evaluator may select a subset of the questions by marking such questions for answer suggestion, or all questions may be processed for answer suggestion. With the form data, a transcript for the interaction may be determined, such as a speech-to-text transformation of a recording of a call or other speech recognition and processing. However, other transcripts may also include digital communications and other data that may be exchanged during or in association with the interaction (e.g., images sent/received, follow-ups, outreach to third parties, etc.). Other contextual data may also assist with narrowing the answer suggestion and providing more on-point and accurate suggested answers, such as additional data for the agent, customer, company, interaction, or the like and/or user defined questions prompt data for user defined prompts for particular questions and their parameters, restrictions, or other information specified by the user.

At step 706, a prompt to an LLM for suggested answers to questions in the performance evaluation is generated based on the evaluation form data and the transcript. A prompt may be generated using one or more prompt templates, strategies, and/or other foundational basis for querying an LLM to provide a response that includes the suggested answers. As such, the prompt may correspond to a set of instructions to the LLM to return a suggested answer, which may define the domain or set of information from which the LLM is to utilize (along with the LLMs training and/or knowledge base) when formulating suggested answers. The prompt may also be generated with a prompting strategy in mind, such as if the LLM is to be prompted in a single call or “shot” or if multiple calls and/or “shots” may be used to request a response from the LLM. As such, multiple prompts or sub-prompts may be linked or correlated for a specific task for answer suggestion.

At step 708, the suggested answers are requested from the LLM using the prompt with a prompting strategy. The prompt may therefore be submitted to the LLM by querying or questioning the LLM using the prompt. This may include providing the instructions with a designation of the information used for answer suggestion to the LLM, such as in a dialog or chat for a conversational AI of the generative AI service hosting the LLM. When prompting the LLM via the conversational AI, the prompting strategy may be used, which, in some embodiments, may correspond to a RAG or direct API calling process.

At step 710, the suggested answers are received from the LLM, and the questions updated in the performance evaluation based on those suggested answers. The LLM may respond to the prompt(s) with the suggested answers in one or more responsive communications, such as via the conversational AI. As such, the suggested answers may then be extracted from the responses and entered to the form of the performance evaluation, which may be used to update and output the form in a user interface of the performance evaluation system to the evaluator. The evaluator may then review the updated form with the suggested answers in the user interface in order to accept the suggested answers, revise such answers, add/delete information, and/or provide a new answer. Where the evaluator requests a new suggested answer including narrowing of the information to be used for answering (e.g., by providing user defined questions prompt data), or the evaluator changes and enters their own answer, the LLM may be retrained and/or further learn so that the LLM may be more accurate with further iterations.

As discussed above and further emphasized here, FIGS. 1-7 are merely examples of contact center system 110 and corresponding methods for automated answer suggestion for questions on agent performance evaluation forms using generative AI, which said examples should not be used to unduly limit the scope of the claims. One of ordinary skill in the art would recognize many variations, alternatives, and modifications.

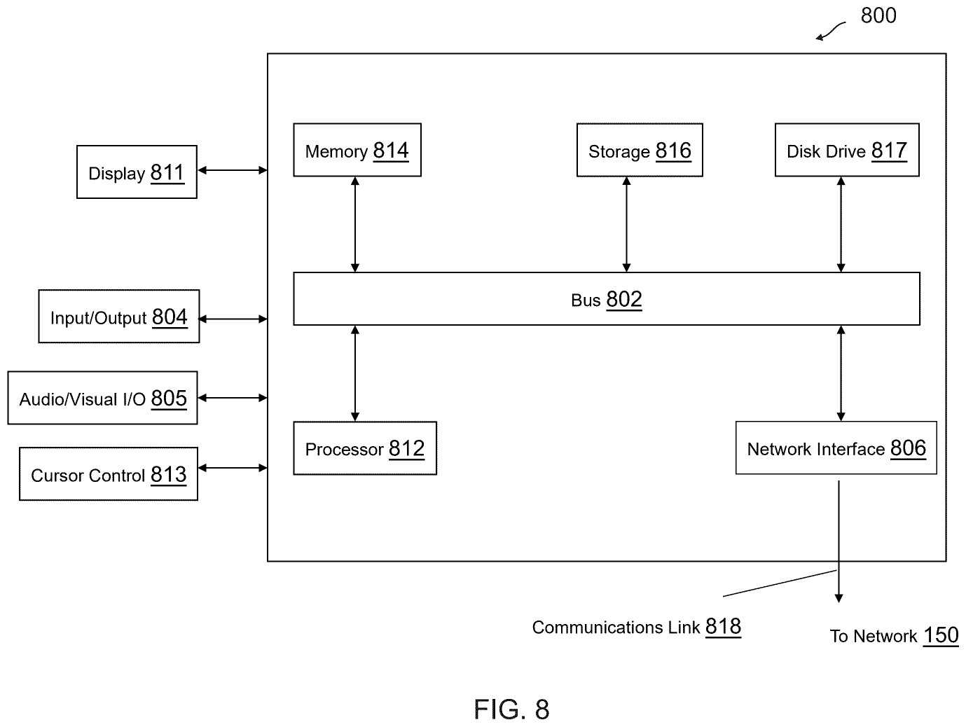

FIG. 8 is a block diagram of a computer system 800 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 800 in a manner as follows.

Computer system 800 includes a bus 802 or other communication mechanism for communicating information data, signals, and information between various components of computer system 800. Components include an input/output (I/O) component 804 that processes a user action, such as selecting keys from a keypad/keyboard, selecting one or more buttons, image, or links, and/or moving one or more images, etc., and sends a corresponding signal to bus 802. I/O component 804 may also include an output component, such as a display 811 and a cursor control 813 (such as a keyboard, keypad, mouse, etc.). An optional audio/visual input/output component 805 may also be included to allow a user to use voice for inputting information by converting audio signals. Audio/visual I/O component 805 may allow the user to hear audio, and well as input and/or output video. A transceiver or network interface 806 transmits and receives signals between computer system 800 and other devices, such as another communication device, service device, or a service provider server via network 150. In one embodiment, the transmission is wireless, although other transmission mediums and methods may also be suitable. One or more processors 812, which can be a micro-controller, digital signal processor (DSP), or other processing component, processes these various signals, such as for display on computer system 800 or transmission to other devices via a communication link 818. Processor(s) 812 may also control transmission of information, such as cookies or IP addresses, to other devices.

Components of computer system 800 also include a system memory component 814 (e.g., RAM), a static storage component 816 (e.g., ROM), and/or a disk drive 817. Computer system 800 performs specific operations by processor(s) 812 and other components by executing one or more sequences of instructions contained in system memory component 814. Logic may be encoded in a computer readable medium, which may refer to any medium that participates in providing instructions to processor(s) 812 for execution. Such a medium may take many forms, including but not limited to, non-volatile media, volatile media, and transmission media. In various embodiments, non-volatile media includes optical or magnetic disks, volatile media includes dynamic memory, such as system memory component 814, and transmission media includes coaxial cables, copper wire, and fiber optics, including wires that comprise bus 802. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 800. In various other embodiments of the present disclosure, a plurality of computer systems 800 coupled by communication link 818 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the scope of the embodiments disclosed herein.

What is claimed is:

1. A performance evaluation system configured to intelligently suggest answers to questions on performance evaluations using a generative artificial intelligence (AI) service, the performance evaluation system comprising:
a processor and a non-transitory computer readable medium operably coupled thereto, the computer readable medium comprising a plurality of instructions stored in association therewith that are accessible to, and executable by, the processor, to perform intelligent suggestion operations which comprise:
receiving a selection of an interaction between a user and an agent of a customer relationship management (CRM) system, wherein the selection designates a performance evaluation that evaluates the agent for the interaction;
fetching evaluation form data for the performance evaluation, wherein the evaluation form data includes one or more questions with one or more answer options to each of the one or more questions;
determining a transcript of the interaction between the user and the agent, wherein the transcript comprises text data available or converted from the interaction;
generating, for the generative AI service comprising at least one large language model (LLM), a request object for one or more suggested answers to the one or more questions based on the one or more answer options and the transcript, wherein the request object prompts the at least one LLM of the generative AI service to respond to the one or more questions with the one or more suggested answers based at least on the one or more answer options and the transcript;
requesting the one or more suggested answers from the generative AI service based on the request object;
responsive to receiving the one or more suggested answers, updating the performance evaluation to include the one or more suggested answer to the one or more questions; and
outputting the updated performance evaluation in an interface of the CRM system for an evaluation process that utilizes the performance evaluation.

2. The performance evaluation system of claim 1, wherein the generating the request object comprises:
processing, using a transcript data processor, the transcript associated with at least one of the interaction and additional relevant data associated with the evaluation form data to create processed transcript data with instructions to set the context of the transcript;
processing, using an evaluation form data processor, the one or more questions, the one or more answer options, and user defined question prompt data to create a question prompt list; and
generating at least one prompt to the at least one LLM based on the processed transcript data, the question prompt list, and a system configuration for communicating with the generative AI service.

3. The performance evaluation system of claim 2, wherein the request object comprises a JavaScript Object Notation (JSON) object including the transcript, the additional relevant data, the one or more questions, the one or more answer options, and the user defined question prompt data, wherein the JSON object is preprocessed by the transcript data processor and the evaluation form data processor, and wherein the one or more suggested answers is received as a JSON response object.

4. The performance evaluation system of claim 2, wherein the requesting the one or more suggested answers comprises:
prompting the at least one LLM using the at least one prompt and one of a retrieval-augmented generation (RAG) process or direct application programming interface (API) calling process.

5. The performance evaluation system of claim 1, wherein, prior to generating the request object, the intelligent suggestion operations further comprise:
filtering the one or more questions for questions marked for autosuggested answers from the generative AI service.

6. The performance evaluation system of claim 1, wherein the generating the request object is further based on additional relevant data associated with at least one of answer guidance, answer policies, or documentation associated with a company entity corresponding to the CRM system.

7. The performance evaluation system of claim 1, wherein the generating the request object is further based on one of user defined prompts comprising user input for a question prompt to the generative AI service or an autogenerated prompts if one of the user defined prompts is not present for a corresponding question.

8. The performance evaluation system of claim 1, wherein the intelligent suggestion operations further comprise:
displaying the one or more suggested answers in association with a corresponding one of the one or more questions;
providing an option to verify or modify the one or more suggested answers; and
responsive to completing each of the one or more questions, publishing the updated performance evaluation having the one or more questions completed based, at least in part, on the one or more suggested answers.

9. The performance evaluation system of claim 8, wherein the intelligent suggestion operations further comprise:
receiving a modification to one of the one or more suggested answers via the option; and providing the modification to the generative AI service for additional learning with the at least one LLM.

10. A method to intelligently suggest answers to questions on performance evaluations using a generative artificial intelligence (AI) service for a performance evaluation system, the method comprising:
receiving a selection of an interaction between a user and an agent of a customer relationship management (CRM) system, wherein the selection designates a performance evaluation that evaluates the agent for the interaction;
fetching evaluation form data for the performance evaluation, wherein the evaluation form data includes one or more questions with one or more answer options to each of the one or more questions;
determining a transcript of the interaction between the user and the agent, wherein the transcript comprises text data available or converted from the interaction;
generating, for the generative AI service comprising at least one large language model (LLM), a request object for one or more suggested answers to the one or more questions based on the one or more answer options and the transcript, wherein the request object prompts the at least one LLM of the generative AI service to respond to the one or more questions with the one or more suggested answers based at least on the one or more answer options and the transcript;
requesting the one or more suggested answers from the generative AI service based on the request object;
responsive to receiving the one or more suggested answers, updating the performance evaluation to include the one or more suggested answer to the one or more questions; and
outputting the updated performance evaluation in an interface of the CRM system for an evaluation process that utilizes the performance evaluation.

11. The method of claim 10, wherein the generating the request object comprises:
processing, using a transcript data processor, the transcript associated with at least one of the interaction and additional relevant data associated with the evaluation form data to create processed transcript data with instructions to set the context of the transcript;
processing, using an evaluation form data processor, the one or more questions, the one or more answer options, and user defined question prompt data to create a question prompt list; and
generating at least one prompt to the at least one LLM based on the processed transcript data, the question prompt list, and a system configuration for communicating with the generative AI service.

12. The method of claim 11, wherein the request object comprises a JavaScript Object Notation (JSON) object including the transcript, the additional relevant data, the one or more questions, the one or more answer options, and the user defined question prompt data, wherein the JSON object is preprocessed by the transcript data processor and the evaluation form data processor, and wherein the one or more suggested answers is received as a JSON response object.

13. The method of claim 11, wherein the requesting the one or more suggested answers comprises:
prompting the at least one LLM using the at least one prompt and one of a retrieval-augmented generation (RAG) process or direct application programming interface (API) calling process.

14. The method of claim 10, wherein, prior to generating the request object, the intelligent suggestion operations further comprise:
filtering the one or more questions for questions marked for autosuggested answers from the generative AI service.

15. The method of claim 10, wherein the generating the request object is further based on additional relevant data associated with at least one of answer guidance, answer policies, or documentation associated with a company entity corresponding to the CRM system.

16. The method of claim 10, wherein the generating the request object is further based on one of user defined prompts comprising user input for a question prompt to the generative AI service or an autogenerated prompts if one of the user defined prompts is not present for a corresponding question.

17. The method of claim 10, further comprising:
displaying the one or more suggested answers in association with a corresponding one of the one or more questions;
providing an option to verify or modify the one or more suggested answers; and
responsive to completing each of the one or more questions, publishing the updated performance evaluation having the one or more questions completed based, at least in part, on the one or more suggested answers.

18. The method of claim 17, wherein the intelligent suggestion operations further comprise:
receiving a modification to one of the one or more suggested answers via the option; and providing the modification to the generative AI service for additional learning with the at least one LLM.

19. A non-transitory computer-readable medium having stored thereon computer-readable instructions executable to intelligently suggest answers to questions on performance evaluations using a generative artificial intelligence (AI) service for a performance evaluation system, the computer-readable instructions executable to perform intelligent suggestion operations which comprise:
receiving a selection of an interaction between a user and an agent of a customer relationship management (CRM) system, wherein the selection designates a performance evaluation that evaluates the agent for the interaction;
fetching evaluation form data for the performance evaluation, wherein the evaluation form data includes one or more questions with one or more answer options to each of the one or more questions;
determining a transcript of the interaction between the user and the agent, wherein the transcript comprises text data available or converted from the interaction;
generating, for the generative AI service comprising at least one large language model (LLM), a request object for one or more suggested answers to the one or more questions based on the one or more answer options and the transcript, wherein the request object prompts the at least one LLM of the generative AI service to respond to the one or more questions with the one or more suggested answers based at least on the one or more answer options and the transcript;
requesting the one or more suggested answers from the generative AI service based on the request object;
responsive to receiving the one or more suggested answers, updating the performance evaluation to include the one or more suggested answer to the one or more questions; and
outputting the updated performance evaluation in an interface of the CRM system for an evaluation process that utilizes the performance evaluation.

20. The non-transitory computer-readable medium of claim 18, wherein the generating the request object comprises:
processing, using a transcript data processor, the transcript associated with at least one of the interaction and additional relevant data associated with the evaluation form data to create processed transcript data with instructions to set the context of the transcript;
processing, using an evaluation form data processor, the one or more questions, the one or more answer options, and user defined question prompt data to create a question prompt list; and
generating at least one prompt to the at least one LLM based on the processed transcript data, the question prompt list, and a system configuration for communicating with the generative AI service.
